(19) United States
(12) Patent Application Publication
(10) Pub. No.: US 2026/0259672 A1
(43) Pub. Date: Sep. 3, 2026

(54) MEMORY MANAGEMENT METHOD AND MEMORY CONTROLLER

(71) Applicant: XIAMEN HOSIN GLOBAL ELECTRONICS CO., LTD, Fujian (CN)

(72) Inventor: Sheng-Chieh Hsu, Fujian (CN)

(73) Assignee: XIAMEN HOSIN GLOBAL ELECTRONICS CO., LTD, Fujian (CN)

(21) Appl. No.: 19/660,156

(22) Filed: Apr. 27, 2026

(30) Foreign Application Priority Data
May 20, 2025 (CN) 202510652047.4

(51) Int. Cl. G06F 3/06

(52) U.S. Cl. CPC G06F 3/0631; G06F 3/0613; G06F 3/0679

(57) ABSTRACT

A memory management method and a memory controller are provided for a storage device having a memory module that includes a plurality of chips, each chip having a plurality of planes, and each plane having a plurality of physical blocks. The method includes: obtaining the number of chip enable signals (CE count) of the memory module; selecting a target allocation method from a plurality of allocation methods according to the CE count, the allocation methods including a first allocation method based on the chips and a second allocation method based on the planes; and dividing the physical blocks into a plurality of super blocks based on the target allocation method. By optimizing the super block allocation strategy, utilization of physical blocks is improved and garbage collection efficiency is enhanced.

### CROSS-REFERENCE TO RELATED APPLICATION

This application claims the priority benefit of China application serial no. 202510652047.4, filed on May 20, 2025. The entirety of the above-mentioned patent application is hereby incorporated by reference herein and made a part of this specification.

### BACKGROUND

### Technical Field

The present disclosure relates to the field of storage technology, and in particular, to a memory management method and a memory controller.

### Description of Related Art

Conventional non-volatile memory management systems typically use a logical super block (Super Block) as the basic management unit during operation. In a typical configuration, a memory array may include a plurality of chip enable signals (CE), a plurality of dies (Die) (i.e., chips), and a plurality of planes (Plane) within each die. In conventional approaches, a super block is typically composed of a plurality of physical blocks having the same physical index across all planes.

This conventional architecture has significant drawbacks: because the conditions for forming a super block require that blocks with the same block index across all planes be bound together for use, when bad blocks (Bad Blocks) are unevenly distributed or present in large quantities in the storage medium, many otherwise available good blocks (hereinafter referred to as "non-defective blocks") cannot be utilized, which may result in failure to meet the expected storage capacity specifications during mass production, causing test failures. Furthermore, as storage device capacity continues to increase, the amount of data contained in a single super block increases correspondingly, which directly leads to a significant increase in processing delay when performing storage space reclamation operations (Garbage Collection, GC), affecting overall system performance.

### SUMMARY

In view of this, the present disclosure provides a memory management method and a memory controller that flexibly select a first allocation method based on chips or a second allocation method based on planes according to the number of chip enable signals (CE count) of the memory module, so as to effectively divide physical blocks and also reduce the size of super blocks.

One or more embodiments of the present disclosure provide a memory management method, applied to a storage device configured with a memory module, wherein the memory module has a plurality of chips, each chip has a plurality of planes, and each plane has a plurality of physical blocks. The method includes: obtaining the number of chip enable signals (CE count) of the memory module; selecting a target allocation method from a plurality of allocation methods according to the CE count, wherein the plurality of allocation methods includes a first allocation method based on the plurality of chips and a second allocation method based on the plurality of planes; and dividing the plurality of physical blocks into a plurality of super blocks based on the selected target allocation method.

In one or more embodiments of the present disclosure, selecting the target allocation method from the plurality of allocation methods according to the CE count includes: when the CE count is not less than a predetermined threshold, selecting the first allocation method as the target allocation method; and when the CE count is less than the predetermined threshold, selecting the second allocation method as the target allocation method.

In one or more embodiments of the present disclosure, the first allocation method based on the plurality of chips includes: dividing the plurality of chips into a plurality of chip enable groups (CEGs), each chip enable group (CEG) containing a first predetermined number of chips; and for each chip enable group (CEG), dividing the same physical blocks in the same plane of all chips within the chip enable group (CEG) into one super block, such that the number of physical blocks in each super block is the first predetermined number multiplied by the number of planes of the plurality of planes.

In one or more embodiments of the present disclosure, the second allocation method based on the plurality of planes includes: dividing the plurality of planes into a plurality of plane groups (PLGs), each plane group (PLG) containing a second predetermined number of planes; and for each plane group (PLG), dividing the same physical blocks within the plane group (PLG) across all chips into one super block, such that the number of physical blocks in each super block is the CE count multiplied by the second predetermined number.

In one or more embodiments of the present disclosure, the method further includes achieving parallel operations using super blocks divided by the first allocation method, wherein the parallel operations include: sending read or write commands respectively to a plurality of super blocks belonging to different chip enable groups (CEGs), so as to achieve inter-super-block parallel operations; within the same super block, simultaneously accessing physical blocks on different chips within the chip enable group (CEG) and utilizing the multi-plane command mechanism to simultaneously operate a plurality of planes within each chip, so as to achieve dual parallelism of inter-chip parallelism and inter-plane parallelism; and when performing garbage collection operations, migrating, as a whole, valid data in a first super block belonging to a first chip enable group (CEG) to a second super block belonging to a second chip enable group (CEG), while utilizing the multi-plane command mechanism to achieve parallel migration of data within chips.

In one or more embodiments of the present disclosure, the method further includes achieving parallel operations using super blocks divided by the second allocation method, wherein the parallel operations include: simultaneously performing different types of operations on a plurality of super blocks belonging to different plane groups (PLGs), such that while a super block of one plane group (PLG) performs a read operation, a super block of another plane group (PLG) can perform a write operation; during garbage collection, simultaneously migrating valid data in a first super block belonging to a first plane group (PLG) to a second super block belonging to a second plane group (PLG); and utilizing the multi-plane command mechanism to simultaneously operate the second predetermined number of planes of each super block.

In one or more embodiments of the present disclosure, wherein the predetermined threshold is 4, the method further includes: when the CE count is not less than 4, selecting the first allocation method as the target allocation method; and when the CE count is less than 4, selecting the second allocation method as the target allocation method.

In one or more embodiments of the present disclosure, wherein the first predetermined number is 2, dividing the plurality of chips into the plurality of chip enable groups (CEGs) includes: every 2 chips forming one chip enable group (CEG); and the 2 chips within each chip enable group (CEG) respectively corresponding to 2 channels.

In one or more embodiments of the present disclosure, wherein the second predetermined number is 2, dividing the plurality of planes into the plurality of plane groups (PLGs) includes: every 2 planes forming one plane group (PLG); and the 2 planes within each plane group (PLG) respectively corresponding to 2 channels.

Based on the above, according to the technical solution of the present disclosure, when the memory module has fewer chip enable signals, the number of super blocks used by the firmware is increased by adopting the plane group (PLG) partitioning method, thereby improving the production yield; when the memory module has more chip enable signals, the memory usage efficiency is improved by the chip enable group (CEG) partitioning method. In addition, due to the reasonable control of the super block capacity, the efficiency of performing garbage collection operations is improved, reducing the amount of data migration and processing time.

### BRIEF DESCRIPTION OF THE DRAWINGS

FIG. 1 is a block diagram of a host system and a storage device according to an embodiment of the present disclosure;

FIG. 2 is a flowchart of a memory management method according to an embodiment of the present disclosure;

FIG. 3 is a schematic diagram of a conventional super block allocation approach according to an embodiment of the present disclosure;

FIG. 4 is a schematic diagram of the first allocation method based on chips according to an embodiment of the present disclosure;

FIG. 5 is a schematic diagram of the second allocation method based on planes according to an embodiment of the present disclosure.

### DESCRIPTION OF THE EMBODIMENTS

Reference will now be made in detail to exemplary embodiments of the present disclosure, examples of which are illustrated in the accompanying drawings. Wherever possible, the same reference symbols are used in the drawings and description to refer to the same or similar parts.

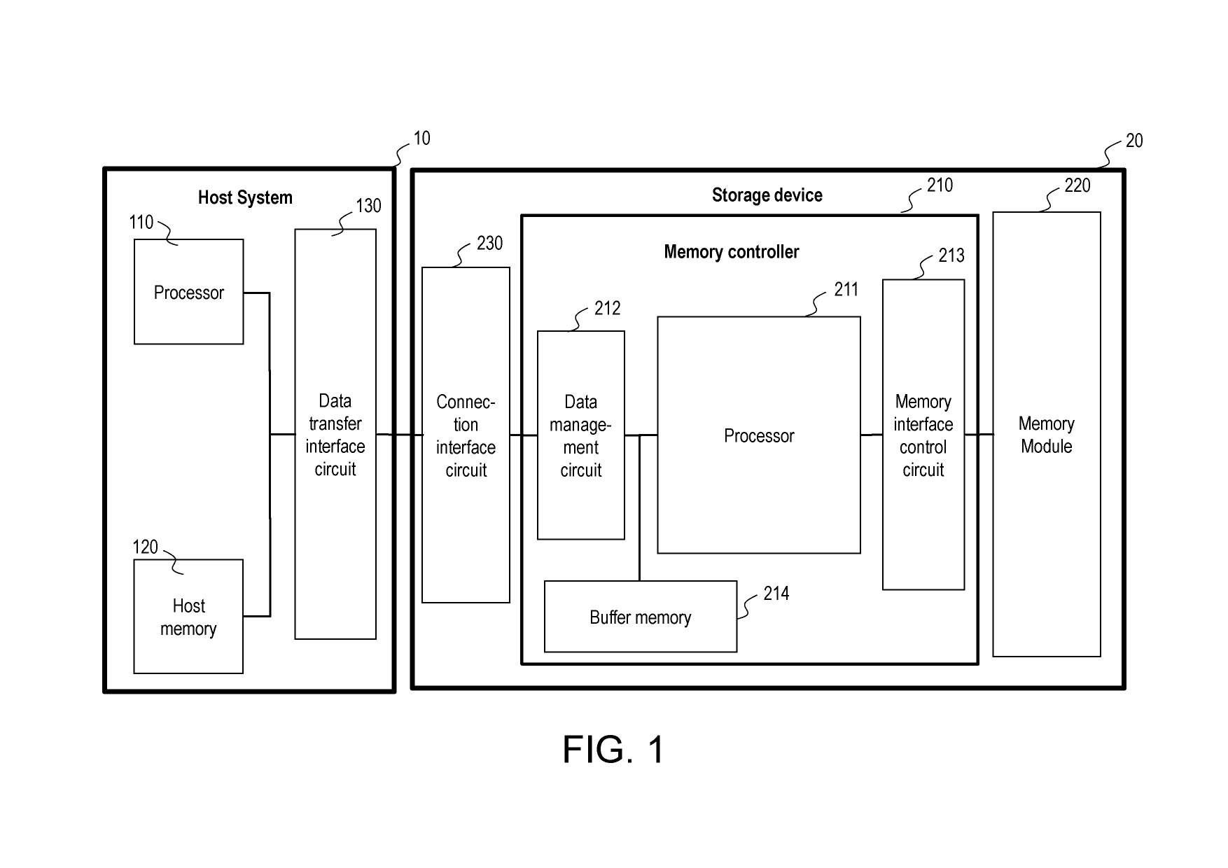

FIG. 1 is a block schematic diagram of a host system and a storage device according to an embodiment of the present disclosure. Referring to FIG. 1, the host system 10 is, for example, a personal computer, a laptop computer, or a server. The host system (Host System) 10 comprises a processor (Processor) 110 (also referred to as the second processor), a host memory (Host Memory) 120 (also referred to as host memory), and a data transfer interface circuit (Data Transfer Interface Circuit) 130. In the present embodiment, the processor 110 is coupled to (also referred to as electrically connected to) the host memory 120 and the data transfer interface circuit 130. In another embodiment, the processor (Processor) 110, the host memory 120, and the data transfer interface circuit 130 are electrically connected to each other via a system bus (System Bus). In the present embodiment, the processor 110, the host memory 120, and the data transfer interface circuit 130 may be disposed on a motherboard of the host system 10.

The storage device 20 comprises a memory controller (Memory Controller) 210, a memory module (Memory Module) 220 (also referred to as a rewritable non-volatile memory module (Rewritable Non-Volatile Memory Module)), and a connection interface circuit (Connection Interface Circuit) 230. The memory controller 210 comprises a processor 211 (also referred to as the first processor), a data management circuit (Data Management Circuit) 212, a memory interface control circuit (Memory Interface Control Circuit) 213, and a buffer memory 214.

In the present embodiment, the host system 10 is electrically connected to the storage device 20 via the data transfer interface circuit 130 and the connection interface circuit 230 of the storage device 20, so as to perform data access operations. For example, the host system 10 may store data on the storage device 20 or read data from the storage device 20 via the data transfer interface circuit 130.

In the present embodiment, the number of the data transfer interface circuit 130 may be one or more. Via the data transfer interface circuit 130, a motherboard may be electrically connected to the storage device 20 in a wired or wireless manner. The storage device 20 may be, for example, a USB flash drive, a memory card, a Solid-State Drive (SSD), or a wireless memory storage device. The wireless memory storage device may be, for example, a Near Field Communication (NFC) memory storage device, a WiFi memory storage device, a Bluetooth memory storage device, or a low-power Bluetooth memory storage device (e.g., iBeacon), and other memory storage devices based on various wireless communication technologies. In addition, the motherboard may also be electrically connected via a system bus to various I/O devices such as a Global Positioning System (GPS) module, a network interface card, a wireless transmission device, a keyboard, a screen, and speakers.

In the present embodiment, the data transfer interface circuit 130 and the connection interface circuit 230 are interface circuits compatible with the Peripheral Component Interconnect Express (PCI Express) standard. Furthermore, data transmission between the data transfer interface circuit 130 and the connection interface circuit 230 is performed using the Non-Volatile Memory express (NVMe) communication protocol.

In addition, in another embodiment, the connection interface circuit 230 may be packaged together with the memory controller 210 in one chip, or the connection interface circuit 230 may be disposed outside a chip containing the memory controller 210.

In the present embodiment, the host memory 120 is configured to temporarily store instructions or data executed by the processor 110. In the present embodiment, the host memory 120 may be a Dynamic Random Access Memory (DRAM), a Static Random Access Memory (SRAM), or the like. However, it should be understood that the present disclosure is not limited thereto, and the host memory 120 may also be other suitable memories.

The memory controller 210 is configured to execute a plurality of logic gates or control instructions implemented in hardware form or firmware form, and to perform write, read, and erase operations on data in the memory module 220 according to instructions from the host system 10.

In more detail, the processor 211 in the memory controller 210 is hardware having computing capability, configured to control the overall operation of the memory controller 210. Specifically, the processor 211 is programmed with a plurality of control instructions/program codes, and when the storage device 20 is in operation, these control instructions/program codes are executed to perform write, read, and erase operations on data. In addition, the processor 211 is configured to execute the memory management method provided by the present disclosure. Specifically, the processor 211 is configured to obtain the number of chip enable signals (CE count) of the memory module 220, wherein the number of chip enable signals (CE count) represents the total number of a plurality of chip enable pins (CEs) of the memory module 220, with each chip enable pin (CE) corresponding to a different chip. The processor 211 is further configured to execute corresponding firmware/program code modules to: select a target allocation method from a plurality of allocation methods according to the number of chip enable signals (CE count), wherein the plurality of allocation methods comprises a first allocation method based on a plurality of chips and a second allocation method based on a plurality of planes. The processor 211 then divides the plurality of physical blocks in the memory module 220 into a plurality of super blocks based on the selected target allocation method. In this way, the memory controller 210 is capable of dynamically selecting the most suitable super block allocation strategy according to the actual hardware configuration of the memory module 220 (i.e., the number of chip enable signals (CE count)), thereby improving the utilization of physical blocks in the memory module 220. In particular, in the presence of a large number of bad blocks, the production yield is effectively improved. At the same time, due to the reasonable control of super block capacity, the efficiency of performing garbage collection operations is also improved.

In other embodiments, the control instructions/program codes corresponding to the data read method may also be implemented as hardware-form circuit units, so as to implement the memory management method provided by the present disclosure.

It is worth noting that, in the present embodiment, the processor 110 and the processor 211 are, for example, a Central Processing Unit (CPU), a micro-processor, or other programmable processing units (Microprocessor), a Digital Signal Processor (DSP), a programmable controller, an Application Specific Integrated Circuit (ASIC), a Programmable Logic Device (PLD), or other similar circuit components, and the present disclosure is not limited thereto.

In the present embodiment, as mentioned above, the memory controller 210 further comprises the data management circuit 212 and the memory interface control circuit 213. It should be noted that operations performed by the respective components of the memory controller 210 may also be regarded as operations performed by the memory controller 210.

The data management circuit 212 is electrically connected to the processor 211, the memory interface control circuit 213, and the connection interface circuit 230. The data management circuit 212 is configured to accept instructions from the processor 211 to perform data transfer. For example, the data management circuit 212 reads data from the host system 10 (e.g., the host memory 120) via the connection interface circuit 230, and writes the read data to the memory module 220 via the memory interface control circuit 213 (e.g., performing corresponding write operations according to various write instructions from the host system 10). As another example, the data management circuit 212 performs a read operation according to a read instruction from the host system 10, reads data from one or more physical units of the memory module 220 via the memory interface control circuit 213 (data may be read from one or more storage units within the one or more physical units), and writes the read data to the host system 10 (e.g., the host memory 120) via the connection interface circuit 230. In another embodiment, the data management circuit 212 may also be integrated into the processor 211.

The memory interface control circuit 213 is configured to accept instructions from the processor 211, and cooperate with the data management circuit 212 to perform write (also referred to as programming, Programming) operations, read operations, or erase operations on the memory module 220.

In addition, data to be written to the memory module 220 is converted, via the memory interface control circuit 213, into a format acceptable to the memory module 220. Specifically, when the processor 211 is to access the memory module 220, the processor 211 transmits a corresponding command sequence to the memory interface control circuit 213 to instruct the memory interface control circuit 213 to perform a corresponding operation. For example, the command sequences may include a write command sequence for instructing writing of data, a read command sequence for instructing reading of data, an erase command sequence for instructing erasing of data, and corresponding command sequences for instructing various memory operations. The command sequences may include one or more signals, or data on a bus. The signals or data may include instruction codes or program codes. For example, a read command sequence may include information such as a read identification code, a memory address, and a physical address.

In addition, the memory controller 210 establishes a logical-to-physical address mapping table (Logical To Physical address mapping table) and a physical-to-logical address mapping table (Physical To Logical address mapping table) to record the mapping relationship between the logical addresses of logical units (e.g., logical blocks, logical pages) allocated to the memory module 220 and the physical addresses of physical units (e.g., physical erase units/physical blocks, physical pages). In other words, the memory controller 210 may look up a physical unit mapped to a logical unit through the logical-to-physical address mapping table (also referred to as the logical-to-physical mapping table) (e.g., look up the physical page mapped to a logical page; look up the physical address mapped to a logical address), and the memory controller 210 may look up a logical unit mapped to a physical unit through the physical-to-logical address mapping table (also referred to as the physical-to-logical mapping table) (e.g., look up the logical page mapped to a physical page; look up the logical address mapped to a physical address).

The buffer memory 214 is electrically connected to the processor 211, and is used to temporarily store data and instructions from the host system 10, data from the memory module 220, and various system data for managing the storage device 20.

The memory module 220 is electrically connected to the memory controller 210 (specifically electrically connected to the memory interface control circuit 213) and is used to store user data transmitted by the host system 10. The memory module 220 has a specific physical structure to support the memory management method of the present disclosure.

Specifically, the memory module 220 comprises a plurality of chips, each chip corresponding to one chip enable pin (CE), wherein the total number of chip enable pins (CEs) defines the number of chip enable signals (CE count) of the memory module 220. Each chip is further subdivided internally into a plurality of planes, and each plane further comprises a plurality of physical blocks. This multi-level physical structure design enables the memory module 220 to support different super block allocation methods.

In the present embodiment, when the number of chip enable signals (CE count) is greater than or equal to a predetermined threshold, the memory controller 210 may adopt the first allocation method based on a plurality of chips to divide the plurality of chips into a plurality of chip enable groups (CEGs); when the number of chip enable signals (CE count) is less than the predetermined threshold, the memory controller 210 may adopt the second allocation method based on a plurality of planes to divide the plurality of planes into a plurality of plane groups (PLGs).

Through this flexible allocation mechanism, the memory controller 210 is able to divide the plurality of physical blocks into a plurality of super blocks of appropriate sizes according to the actual hardware configuration of the memory module 220, so as to optimize storage system performance and improve the utilization rate of the memory module 220.

In addition, each physical block in the memory module 220 further comprises a plurality of physical pages, and each physical page comprises a plurality of memory cells. It should be noted that the present disclosure is not limited to the size of each physical page or logical page.

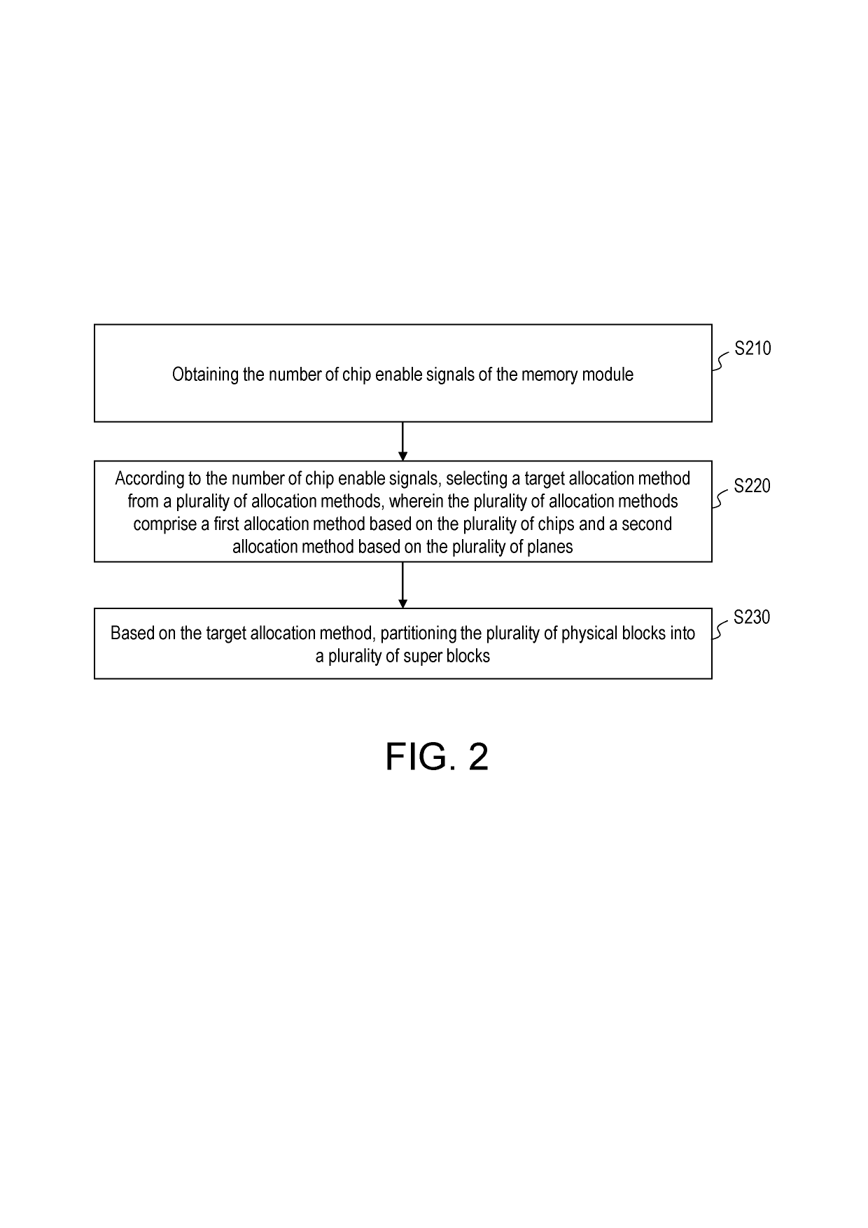

In an embodiment, referring to FIG. 2, FIG. 2 is a flowchart of a memory management method according to an embodiment of the present disclosure. The memory management method is applied to the storage device 20 configured with the memory module 220, wherein the memory module 220 has a plurality of chips, each chip has a plurality of planes, and each plane has a plurality of physical blocks. In the present embodiment, the memory management method is executed by the memory controller 210 in the storage device 20 and specifically may be executed by the processor 211 in the memory controller 210. The memory management method as specifically shown in FIG. 2 comprises the following steps:

In step S210, the memory controller 210 obtains the number of chip enable signals (CE count) of the memory module 220, wherein the number of chip enable signals (CE count) represents the total number of chip enable pins (CEs) of the memory module 220, with each chip enable pin (CE) corresponding to a different chip.

Specifically, the memory controller 210 may identify and calculate the number of chip enable signals (CE count) through various hardware-level methods. For example, the memory controller 210 may obtain the number of chip enable signals (CE count) by reading a configuration register of the memory module 220, wherein the configuration register is typically located in a control register bank of the memory module 220 and stores information representing the current hardware configuration.

Another method is to directly detect the number of chip enable signal lines actually connected to the memory module 220; during the initialization phase, the memory controller 210 may determine the number of actually connected chips by sending a specific identification command sequence to each chip enable pin (CE) and detecting the response signals. In addition, the memory controller 210 may also read the Serial Identification Code internal to the memory module 220, which contains chip enable configuration information.

In step S220, the memory controller 210 selects a target allocation method from a plurality of allocation methods according to the number of chip enable signals (CE count), wherein the plurality of allocation methods comprises a first allocation method based on the plurality of chips and a second allocation method based on the plurality of planes.

Specifically, the memory controller 210 may select an appropriate allocation method according to the comparison result between the number of chip enable signals (CE count) and a predetermined threshold. When the number of chip enable signals (CE count) is not less than the predetermined threshold, the first allocation method is selected as the target allocation method; and when the number of chip enable signals (CE count) is less than the predetermined threshold, the second allocation method is selected as the target allocation method.

In an embodiment, the predetermined threshold is set to 4, and the selection of this value is based on the following technical considerations: when the number of chip enable signals (CE count) reaches 4, at least two chip enable groups (CEGs) (each comprising 2 chips) can be formed, enabling the first allocation method to be effectively implemented; at the same time, 4 chip enable signals typically correspond to the optimal configuration of the 2-channel memory controller 210, enabling the parallel processing capability of the memory controller 210 to be utilized. The selection of different thresholds directly affects system performance.

For example, if the predetermined threshold is set to 2, almost all configurations will adopt the first allocation method, which cannot optimize for low chip count scenarios; if the threshold is set to 8, medium-scale storage devices will also adopt the second allocation method, potentially failing to utilize inter-chip parallelism.

Therefore, when the number of chip enable signals (CE count) is not less than 4, the memory controller 210 selects the first allocation method based on the plurality of chips as the target allocation method; when the number of chip enable signals (CE count) is less than 4, the memory controller 210 selects the second allocation method based on the plurality of planes as the target allocation method.

It should be understood that the aforementioned predetermined threshold (i.e., 4) may be adjusted according to the specific configuration of the memory module 220, the controller architecture, or system requirements. In some embodiments, the predetermined threshold may be set to other values, such as 2, 6, or 8, to accommodate the requirements of different hardware platforms or application scenarios. The memory controller may set and update the threshold through configuration registers or firmware parameters, so as to achieve a more flexible super block allocation strategy.

In step S230, the memory controller 210 divides the plurality of physical blocks into a plurality of super blocks based on the selected target allocation method. This partitioning process involves specific algorithm and data structure implementations.

When the first allocation method is selected as the target allocation method, the memory controller first creates a chip enable group mapping table, assigns sequential numbers to the plurality of chips (e.g., CE0, CE1, CE2, CE3...), and then assigns every two adjacent numbered chips to the same chip enable group (CEG), forming a chip enable group list, wherein the two chips within each chip enable group (CEG) correspond to different channels respectively (for example, CE0 corresponds to channel 0 and CE1 corresponds to channel 1), so as to utilize multi-channel parallel processing capability. The memory controller 210 then assigns a unique identifier to each chip enable group (CEG) and internally maintains a chip enable group information table recording the specific chips contained in each chip enable group (CEG).

For each chip enable group (CEG), the memory controller 210 divides the physical blocks at the same index number and same plane position across all chips within the chip enable group (CEG) into one super block, and assigns a globally unique identifier to each super block. The memory controller also maintains a super block mapping table recording the specific physical block information contained in each super block.

When the second allocation method is selected as the target allocation method, the memory controller 210 first creates a plane mapping table, assigns sequential numbers to the plurality of planes within each chip (e.g., Plane0, Plane1, Plane2, Plane3...), and then assigns every two adjacent numbered planes to the same plane group (PLG), forming a plane group list. Similarly, the memory controller 210 assigns a unique identifier to each plane group (PLG) and maintains a plane group information table.

For each plane group (PLG), the memory controller divides the same physical block index numbers within the plane group (PLG) of all chips into one super block, and maintains a corresponding super block mapping table.

The super block, as the fundamental unit of data management, plays a key role in storage systems. During data write operations, the memory controller 210 allocates write positions according to the currently active super block, and updates the mapping table.

For example, when the first allocation method is adopted, data write operations may be performed in parallel among the plurality of chips within the chip enable group (CEG), and the plurality of planes of each chip may also be operated in parallel, thereby improving write efficiency. During data read operations, the memory controller 210 queries the mapping table to determine the super block in which the data resides, and then reads the relevant physical blocks in parallel. During garbage collection, the memory controller 210 selects super blocks with a higher proportion of invalid pages, migrates the valid data thereof to new super blocks, and then erases the entire super block.

The super block structure under different allocation methods directly affects garbage collection efficiency. Smaller super blocks (such as those formed when adopting the first and second allocation methods) generally reduce the amount of data migration per garbage collection operation, thereby reducing processing time.

In terms of address mapping, the memory controller 210 maintains a mapping relationship from logical addresses to super blocks, which is then refined to mappings of specific physical blocks within the super blocks. This two-level mapping structure enables the system to both efficiently manage super blocks and precisely locate specific data positions. When the first allocation method is adopted, the mapping table needs to record the correspondence from logical addresses to chip enable groups (CEGs), chips within the chip enable group (CEG), planes, and physical blocks; when the second allocation method is adopted, the mapping table needs to record the correspondence from logical addresses to chips, plane groups (PLGs), planes within the plane group (PLG), and physical blocks.

Specifically, in an embodiment, when the number of chip enable signals (CE count) is 4 or more, the memory controller 210 selects the first allocation method, dividing every 2 chips into one chip enable group (CEG) (e.g., each chip enable group (CEG) comprises a first predetermined number of chips, the first predetermined number being 2), for example forming 2 chip enable groups (CEGs) in the case of 4 chips. Then, for each chip enable group (CEG), the same physical blocks of the same plane of the 2 chips within the chip enable group (CEG) are divided into one super block. Assuming each chip has 4 planes, each super block comprises 2 chips x 4 planes = 8 physical blocks.

In another embodiment, when the number of chip enable signals (CE count) is 2, since chip enable group partitioning is not feasible, the memory controller 210 selects the second allocation method, dividing the 4 planes of each chip into 2 plane groups (PLGs), each plane group (PLG) comprising 2 planes (e.g., each plane group (PLG) comprises a second predetermined number of planes, the second predetermined number being 2). Then, for each plane group (PLG), the same physical blocks within the plane group (PLG) of all chips are divided into one super block. In the case of 2 chips, each super block comprises 2 chips x 2 planes = 4 physical blocks.

Through this mechanism, even when the number of chips is limited, the system is still capable of forming smaller super blocks, effectively improving memory utilization and optimizing garbage collection efficiency. In particular, when the chip count is low and a large number of bad blocks exist, the plane group partitioning approach can effectively improve physical block utilization, thereby enhancing production yield. At the same time, due to the reduction in super block capacity, data can be processed more efficiently during garbage collection operations, reducing processing time and resource consumption. According to actual testing, when the first allocation method is adopted to reduce the super block size from 16 physical blocks to 8 physical blocks, the time required for garbage collection operations is reduced by approximately half; when the second allocation method is adopted to further reduce the super block to 4 physical blocks, the garbage collection time can be reduced to approximately one quarter of that of the conventional method. This is because the amount of data to be processed is proportional to the super block size, and smaller super blocks not only reduce the amount of data migration per garbage collection operation, but also improve parallel processing efficiency.

Furthermore, during garbage collection, the super block serves as the basic unit of operation, and its size directly affects processing efficiency. Smaller super blocks allow for more fine-grained management, reducing the amount of data migration and improving parallelism. For example, when the plane group allocation method is used, a read operation may be performed on one plane group (PLG) while a write or garbage collection operation is performed on another plane group (PLG), improving the overall system throughput.

It is worth noting that, in another embodiment of the present disclosure, by utilizing the partitioning structure of chip enable groups (CEGs) and plane groups (PLGs), a more advanced dynamic data management strategy may be implemented. The memory controller 210 may classify data into hot data (frequently updated) and cold data (unchanged for a long period) based on analysis of the access frequency of stored data, and allocate them to different super blocks respectively.

Specifically, when the first allocation method is adopted to form a plurality of chip enable groups (CEGs), the memory controller 210 may dedicate a specific chip enable group (CEG) (e.g., a first chip enable group (CEG)) to storing hot data, while using other chip enable groups (CEGs) (e.g., a second chip enable group (CEG)) to store cold data. Similarly, when the second allocation method is adopted to form a plurality of plane groups (PLGs), a specific plane group (PLG) may be dedicated to hot data storage, while other plane groups (PLGs) are used for cold data storage.

This dynamic allocation strategy based on data access characteristics has multiple advantages: first, the physical isolation of hot data and cold data reduces the amount of valid data migrated during garbage collection operations; second, the wear level of different super blocks may be more balanced, extending the overall memory lifetime; finally, the system may adopt different garbage collection trigger thresholds and execution strategies for hot data super blocks and cold data super blocks respectively, improving overall system performance.

In addition, the memory controller 210 may also periodically re-evaluate data access patterns and dynamically adjust the allocation of data among different super blocks to adapt to changes in application workload. For example, when certain data is detected to have transitioned from hot data to cold data, it may be migrated to a cold data super block during the next garbage collection cycle, and vice versa. This adaptive data management mechanism further enhances the flexibility and efficiency of the storage system.

In another embodiment of the present disclosure, the memory controller 210 may further implement a dynamic role-switching mechanism between chip enable groups (CEGs) and plane groups (PLGs) to optimize the wear leveling effect. Specifically, the memory controller 210 may periodically evaluate the wear status of each chip enable group (CEG) or plane group (PLG) and swap their data storage roles when specific conditions are triggered.

For example, when it is detected that the erase count of the first chip enable group (CEG) used for storing hot data reaches the predetermined threshold, or when the difference in erase count from the second chip enable group (CEG) used for storing cold data exceeds a specific percentage, the memory controller 210 may trigger a role-switching operation. During the role-switching process, the memory controller 210 will stop allocating new hot data to the first chip enable group (CEG) and instead allocate to the second chip enable group (CEG), while allocating new cold data to the first chip enable group (CEG). For data already stored, the memory controller 210 may gradually complete the data migration in subsequent garbage collection operations to ensure that system performance is not significantly affected.

This dynamic role-switching mechanism is equally applicable in the plane group allocation method. When a plane group (PLG) experiences accelerated wear due to long-term storage of hot data, its role may be switched to a cold data storage area, while the original cold data plane group (PLG) is upgraded to a hot data storage area.

By implementing this periodic role-switching strategy, the memory controller 210 may effectively balance the wear distribution among chip enable groups (CEGs) and plane groups (PLGs), preventing certain physical units from prematurely exhausting their write cycles and affecting the overall storage system lifetime. In addition, this strategy may also reduce the impact of uneven bad block distribution in flash memory dies on system capacity, further improving the lifespan and reliability of the storage device.

The role-switching mechanism may be implemented by adjusting the mapping table in the memory controller 210, without physically moving data, thereby minimizing performance overhead. The memory controller 210 may maintain specific metadata to record the current role and cumulative erase count of each chip enable group (CEG) and plane group (PLG) to support the decision-making process.

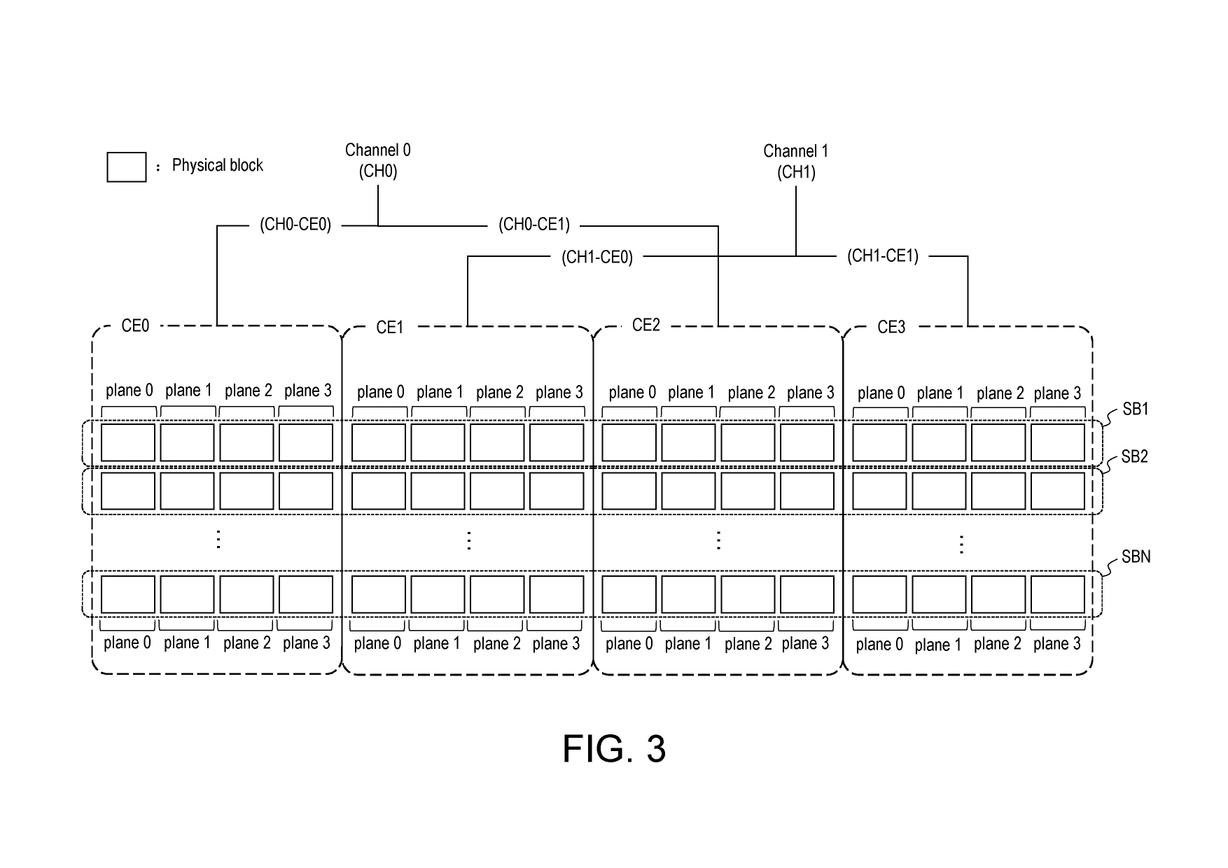

In an embodiment, referring to FIG. 3, FIG. 3 is a schematic diagram illustrating a conventional super block allocation scheme according to an embodiment of the present disclosure. In this embodiment, it is assumed that the memory module 220 has 4 chip enable signals (CE0, CE1, CE2, and CE3), each chip has 4 planes (plane 0, plane 1, plane 2, and plane 3), and each plane contains a plurality of physical blocks. The blank squares in the figure represent physical blocks. In addition, it is assumed that the memory module 220 has two channels (channel 0 and channel 1).

In the conventional super block allocation scheme, the memory controller adopts an all-plane all-chip bundling allocation strategy, combining physical blocks at the same index position across all planes of all chips into one super block. Taking FIG. 3 as an example, each super block formed by the conventional scheme comprises the corresponding physical blocks in 4 planes (plane 0, plane 1, plane 2, and plane 3) of 4 chips (CE0, CE1, CE2, and CE3), totaling 16 physical blocks constituting one super block. In FIG. 3, SB1, SB2, through SBN represent different super blocks with index numbers from 1 to N respectively.

It should be noted that, although this conventional super block allocation scheme is capable of utilizing the advantages of parallel write and read operations, it has the following drawbacks:

First, when bad blocks are unevenly distributed in the memory module 220, it may lead to resource waste. For example, if a bad block exists in plane 1 of CE0, and the position (index number) corresponding to the bad block is a non-defective block in other chips and planes, those non-defective blocks at the same index number within the same super block cannot be utilized either, because the condition for forming a super block requires that all 16 blocks at each position must be available.

As the number of bad blocks increases, particularly after flash memory dies have aged, this waste becomes more severe and may result in failure to achieve the expected capacity during mass production, leading to reported failures. However, if the first and second allocation methods are used to partition super blocks, under the same bad block distribution, another group of super blocks may still be usable, thereby preserving 50% of the effective capacity.

For the mass production process, this means that even when the quality of flash memory chips varies, by applying the first and second allocation methods of the present disclosure to divide super blocks, the storage capacity required by product specifications can be more easily achieved, so as to improve production yield.

Furthermore, the super blocks formed by the conventional approach have a larger capacity (16 physical blocks), and the amount of data to be processed when performing a garbage collection operation on the corresponding super block increases accordingly, resulting in increased time consumption for garbage collection and affecting system performance. This problem becomes more pronounced particularly when the storage capacity is further increased.

FIG. 3 illustrates the conventional super block allocation approach, in which physical blocks with the same index across all planes of all chips are organized into a unified super block. This approach lacks the flexibility to adapt to uneven distributions of bad blocks, and the excessively large super block capacity leads to reduced garbage collection efficiency.

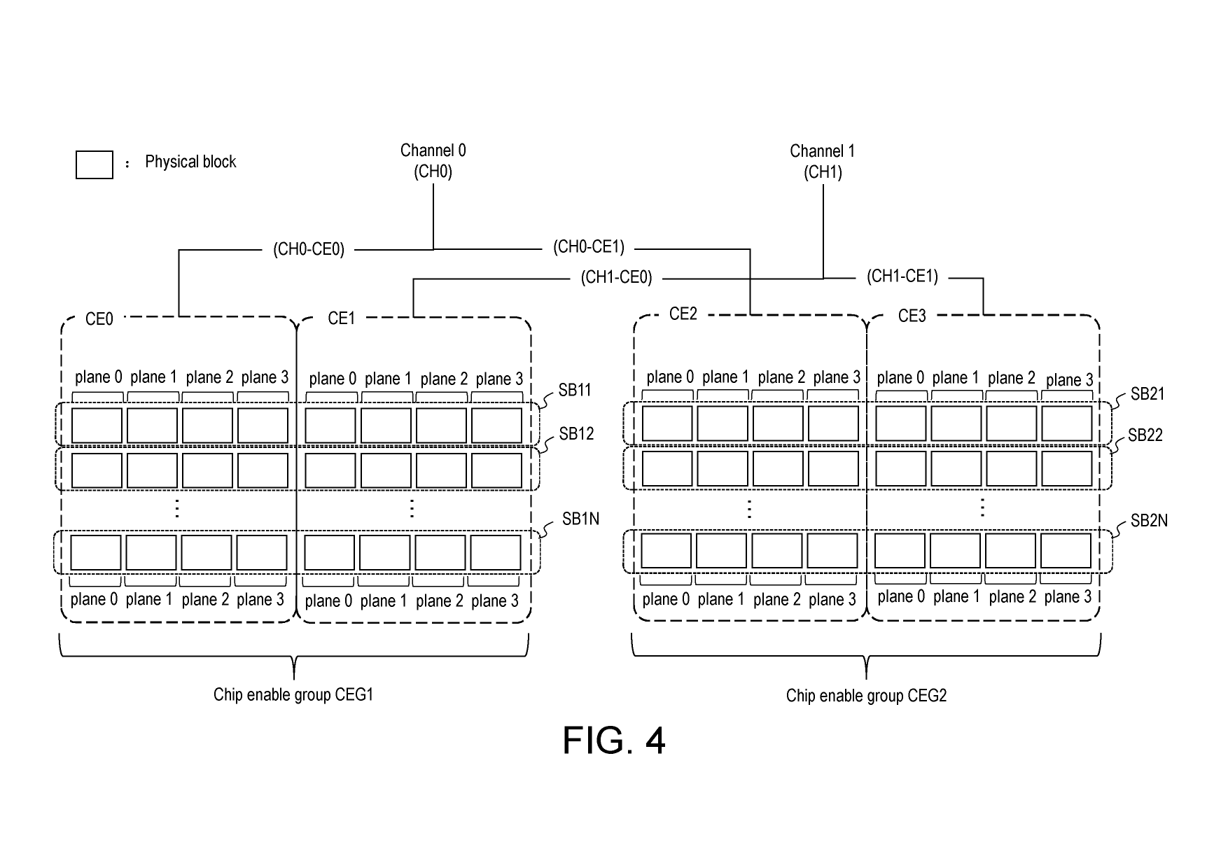

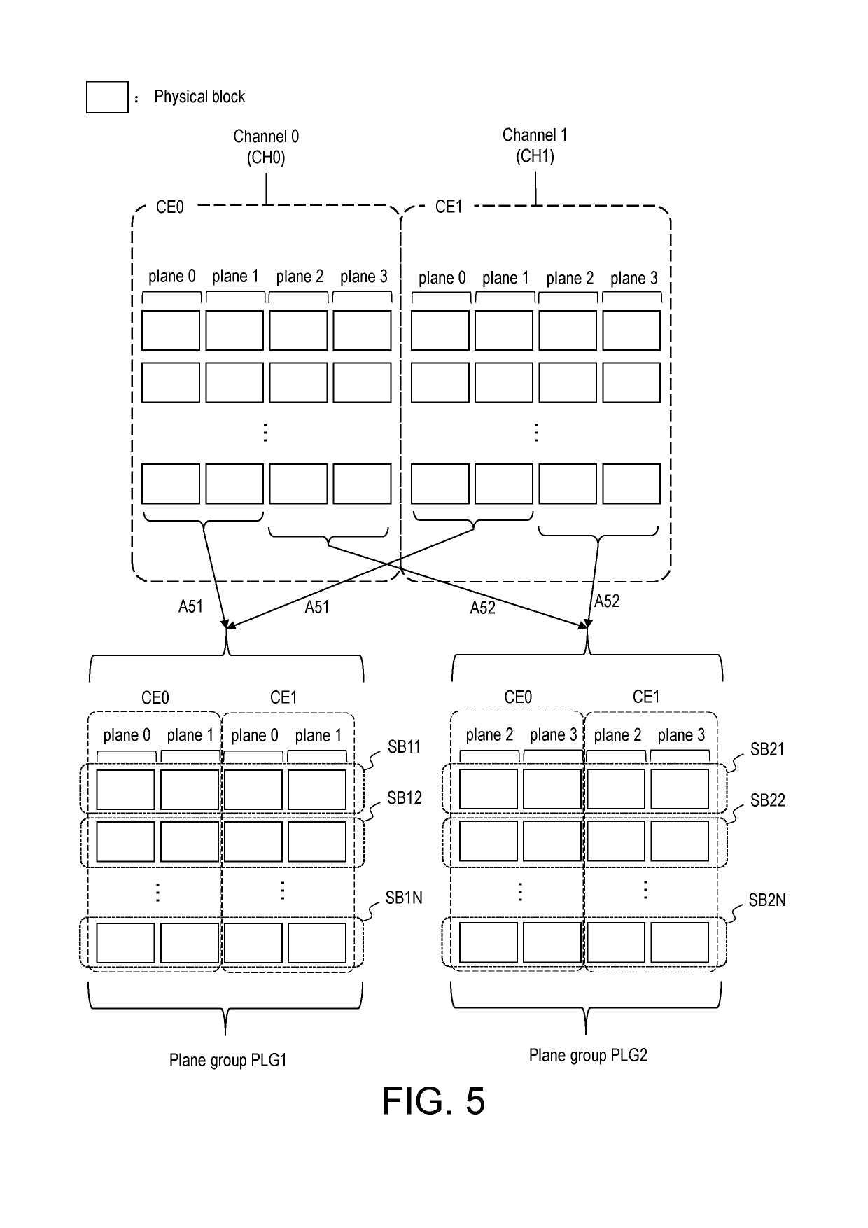

Compared to the conventional approach, the memory management method provided by the present disclosure flexibly selects the first allocation method based on chips (further described with reference to FIG. 4) or the second allocation method based on planes (further described with reference to FIG. 5) according to the number of chip enable signals (CE count) of the memory module 220, so as to form smaller super blocks, thereby more effectively utilizing available physical blocks and improving garbage collection efficiency.

In an embodiment, referring to FIG. 4, FIG. 4 is a schematic diagram illustrating the first allocation method based on chips according to an embodiment of the present disclosure. The figure shows the super block allocation when the memory module 220 has 4 chip enable signals (CE0, CE1, CE2, and CE3). In FIG. 4, blank squares represent physical blocks. As shown in the figure, the storage system has two channels, namely channel 0 (CH0) and channel 1 (CH1), for parallel communication with the memory module 220.

In the present embodiment, the memory controller 210, based on the first allocation method, divides the 4 chips into 2 chip enable groups (CEGs), namely chip enable group CEG1 and chip enable group CEG2. Chip enable group CEG1 comprises chip CE0 and chip CE1, and chip enable group CEG2 comprises chip CE2 and chip CE3.

It is worth noting that the chips within each chip enable group (CEG) are respectively mapped to different channels to achieve channel-level parallel processing. Specifically, chip CE0 is mapped to the first chip position of channel 0 (CH0-CE0), chip CE1 is mapped to the first chip position of channel 1 (CH1-CE0), chip CE2 is mapped to the second chip position of channel 0 (CH0-CE1), and chip CE3 is mapped to the second chip position of channel 1 (CH1-CE1). This mapping relationship enables the memory controller 210 to simultaneously access two chips within each chip enable group (CEG) through two channels.

Based on the chip enable group (CEG) division, the memory controller 210 performs super block division on the physical blocks. For chip enable group CEG1, the memory controller 210 divides the physical blocks having the same index number from the same plane of chip CE0 and chip CE1 within the chip enable group (CEG) into one super block. For example, super block SB11 comprises physical blocks at the same index position across plane 0, plane 1, plane 2, and plane 3 of chip CE0 and plane 0, plane 1, plane 2, and plane 3 of chip CE1, totaling 8 physical blocks. Similarly, super block SB12 comprises physical blocks at another same index position across all planes of chip CE0 and chip CE1, and so on up to super block SB1N.

Similarly, for chip enable group CEG2, the memory controller divides the physical blocks having the same index number from the same plane of chip CE2 and chip CE3 within the chip enable group (CEG) into one super block. For example, super block SB21 comprises physical blocks at the same index position across plane 0, plane 1, plane 2, and plane 3 of chip CE2 and plane 0, plane 1, plane 2, and plane 3 of chip CE3, totaling 8 physical blocks. And so on, forming super blocks SB22 through SB2N.

Compared to the conventional super block allocation approach, the first allocation method in the present embodiment forms super blocks with a smaller capacity (under the same physical architecture, after applying the first allocation method, each super block comprises 8 physical blocks rather than the conventional 16 physical blocks), so as to reduce the amount of data migration when performing a garbage collection operation and improve processing efficiency. In addition, since the super blocks of each chip enable group (CEG) are managed independently, when a bad block occurs in a physical block within one chip enable group (CEG), only the super blocks of that chip enable group (CEG) are affected, without affecting the super blocks of other chip enable groups (CEGs), thereby improving the utilization of physical blocks.

In actual operation, when the memory controller 210 performs a write operation, write commands may be simultaneously sent to the super blocks of chip enable group CEG1 and chip enable group CEG2 (e.g., SB11 and SB21) respectively, implementing parallel writes between super blocks. Within each chip enable group (CEG), the memory controller 210 may simultaneously access different chips within the chip enable group (CEG) (e.g., CE0 and CE1) and utilize the multi-plane command mechanism to simultaneously operate a plurality of planes within each chip, thereby implementing dual parallelism of inter-chip parallelism and intra-plane parallelism and improving data write and read efficiency.

In addition, when performing a garbage collection operation, the memory controller may migrate, as a whole, valid data in super block SB1N of chip enable group CEG1 to super block SB2N of chip enable group CEG2, while utilizing the multi-plane command mechanism to implement parallel migration of data within chips, further optimizing garbage collection performance.

Based on the chip enable group (CEG) division described above, the memory controller 210 may implement multi-level parallel operations.

In an embodiment, the memory controller 210 may implement parallel operations between super blocks. Specifically, the memory controller 210 may send read or write commands respectively to a plurality of super blocks belonging to different chip enable groups (CEGs), processing these commands simultaneously. For example, the memory controller 210 may simultaneously send write commands to super block SB11 of chip enable group CEG1 and super block SB21 of chip enable group CEG2, with the two super blocks executing write operations in parallel, so as to improve overall throughput. Similarly, the memory controller 210 may also simultaneously send read commands to super block SB12 and super block SB22, implementing parallel reads. This parallel operation between super blocks effectively utilizes the hardware resources of the storage device 20 and improves data processing efficiency.

In an embodiment, the memory controller 210 may implement dual parallelism of inter-chip parallelism and intra-plane parallelism within a same super block.

Taking super block SB11 as an example, the memory controller 210 may simultaneously access the physical blocks on chip CE0 and chip CE1 within chip enable group CEG1, implementing inter-chip parallelism. Meanwhile, the memory controller 210 may utilize the multi-plane command mechanism to simultaneously operate plane 0, plane 1, plane 2, and plane 3 within chip CE0, as well as plane 0, plane 1, plane 2, and plane 3 within chip CE1, implementing intra-plane parallelism.

This dual parallelism mechanism greatly enhances the access efficiency of super block SB11, enabling the processing of data from 8 physical blocks in a single operation, thereby fully leveraging the parallel processing potential of flash memory.

In an embodiment, when performing a garbage collection operation, the memory controller 210 may utilize the super block structure formed by the first allocation method to achieve efficient data migration. For example, when it is necessary to reclaim super block SB1N (the first super block) in chip enable group CEG1, the memory controller 210 may migrate, as a whole, the valid data therein to super block SB2N (the second super block) in chip enable group CEG2. In this process, the memory controller 210 simultaneously utilizes the multi-plane command mechanism to implement parallel migration of data across the planes within chip CE0 and chip CE1.

Specifically, the memory controller 210 may read the valid data from chip CE0 and chip CE1 in parallel and write the data to chip CE2 and chip CE3 in parallel through channel 0 (CH0) and channel 1 (CH1). This parallel data migration mechanism significantly reduces the time required for the garbage collection operation and improves overall system performance.

For example, when it is necessary to reclaim super block SB1N (the first super block) in chip enable group CEG1, the memory controller 210 may migrate, as a whole, the valid data therein to super block SB2N (the second super block) in chip enable group CEG2. This parallel data migration process may be implemented through the following sequential operations:

Stage 1 (Parallel Read):
1. At time T1: the memory controller 210 sends a read command to chip CE0 through channel 0 (CH0) and simultaneously sends a read command to chip CE1 through channel 1 (CH1).
2. At time T2: the memory controller 210, through the multi-plane command mechanism, simultaneously activates plane 0, plane 1, plane 2, and plane 3 of chip CE0, as well as plane 0, plane 1, plane 2, and plane 3 of chip CE1.
3. At time T3: each plane simultaneously begins the read operation, transferring the valid data to the buffer memory 214 of the memory controller 210.

Stage 2 (Data Processing):
4. At time T4: the processor 211 of the memory controller 210 processes the valid data in the buffer memory 214, preparing for the write operation.
5. At time T5: the processor 211 updates the mapping table, establishing the mapping relationship between the data and the target super block SB2N.

Stage 3 (Parallel Write):
6. At time T6: the memory controller 210 sends a write command to chip CE2 through channel 0 (CH0) and simultaneously sends a write command to chip CE3 through channel 1 (CH1).
7. At time T7: the memory controller 210, through the multi-plane command mechanism, simultaneously activates plane 0, plane 1, plane 2, and plane 3 of chip CE2, as well as plane 0, plane 1, plane 2, and plane 3 of chip CE3.
8. At time T8: all planes simultaneously begin write operations, writing the valid data in the buffer memory 214 to the corresponding physical blocks of super block SB2N.

Stage 4 (Erase Operation):
9. At time T9: after data migration is complete, the memory controller 210 confirms that all valid data has been safely migrated.
10. At time T10: the memory controller 210 simultaneously sends erase commands to chip CE0 and chip CE1, performing a parallel erase operation on super block SB1N.
11. At time T11: after the erase is complete, super block SB1N is marked as available and may be used for subsequent data writing.

In the above process, since chip enable group CEG1 and chip enable group CEG2 correspond to different physical resources respectively, and the chips within each chip enable group (CEG) are connected to different channels respectively, the memory controller 210 is capable of achieving true parallel data processing. Read and write operations may be performed simultaneously between different chip enable groups (CEGs), while within each chip enable group (CEG), dual parallelism of inter-chip parallelism and intra-plane parallelism may also be achieved.

Compared to conventional methods, this parallel data migration mechanism reduces the time required for data migration operations during garbage collection, due to the reduction in the amount of data processed.

In another embodiment, referring to FIG. 4, the memory controller 210 may utilize NVMe data transfer characteristics to implement a direct data transfer mechanism between super blocks, further optimizing the efficiency of garbage collection operations. This mechanism primarily reduces the transit time of data in the buffer memory 214 through direct data channels between chips, so as to accelerate the migration process of valid data.

Specifically, the memory controller 210 is configured with a direct data transfer circuit capable of establishing a direct data channel from super block SB1N of chip enable group CEG1 to super block SB2N of chip enable group CEG2. Under this configuration, the optimized timing sequence of the garbage collection process is as follows:

Phase 1 (Address Mapping Preparation):
1. At time T1: the processor 211 of the memory controller 210 analyzes the distribution of valid data in super block SB1N and determines the data pages that need to be migrated.
2. At time T2: the processor 211 pre-calculates and establishes a mapping relationship from the source address (valid data in super block SB1N) to the destination address (available space in super block SB2N).

Phase 2 (Channel Configuration and Direct Transfer):

3. At time T3: the memory controller 210 configures channel 0 (CH0) to establish a direct data channel from chip CE0 to chip CE2 and simultaneously configures channel 1 (CH1) to establish a direct data channel from chip CE1 to chip CE3.

4. At time T4: the memory controller 210 sends special read commands to chip CE0 and chip CE1, specifying that data should be directly transferred to the corresponding target chips rather than returned to the memory controller 210.

5. At time T5: the memory controller 210 simultaneously sends special receive commands to chip CE2 and chip CE3, preparing to receive data streams from the source chips.

Phase 3 (Parallel Direct Transfer):
6. At time T6: on channel 0, valid data in plane 0, plane 1, plane 2, and plane 3 of chip CE0 begins to be transferred directly to the corresponding planes of chip CE2.
7. At time T7: on channel 1, valid data in plane 0, plane 1, plane 2, and plane 3 of chip CE1 begins to be transferred directly to the corresponding planes of chip CE3.
8. At time T8: the data transfer process is monitored by a dedicated data transfer control circuit, ensuring transfer integrity and correctness.

Phase 4 (Verification and Completion):
9. At time T9: the memory controller 210 verifies the data transfer completion status, confirming that all valid data has been successfully migrated.
10. At time T10: the processor 211 updates the mapping table, remapping logical addresses to new physical locations (super block SB2N).
11. At time T11: the memory controller 210 sends an erase command to chip enable group CEG1, performing a parallel erase operation on super block SB1N.

Compared with the conventional method of relaying data through the buffer memory 214, this direct data transfer mechanism offers the following performance advantages:
(1) Reduced data transfer latency: since data does not need to be first transferred to the controller and then transmitted out, the transfer path is shortened and latency is reduced.
(2) Improved system resource utilization: the buffer memory 214 is not occupied for data relaying, and may be used simultaneously to process other storage requests, improving the parallel processing capability of the system.
(3) Reduced controller processing load: data does not undergo direct processing by the processor 211, reducing the processor load and enabling it to execute other tasks simultaneously.
(4) Optimized power consumption: the number of data transfers within the system is reduced, lowering power consumption, making it particularly suitable for mobile storage devices and low-power application scenarios.

It is worth noting that this direct data transfer mechanism requires the memory module 220 to support a chip-to-chip data transfer protocol (referring to the communication specification for implementing direct data transfer between different chips in a flash memory storage system), and requires the memory controller 210 to have the capability to configure and manage direct data channels. In actual implementations, the memory controller 210 may need to first perform a compatibility check to confirm that the memory module 220 supports such advanced transfer modes before enabling this function.

By implementing this direct data transfer mechanism, the storage device 20 further improves garbage collection efficiency while maintaining the advantages of the first allocation method, providing the storage system with higher data processing performance and resource utilization.

By implementing the aforementioned multi-level parallel operations, super blocks divided based on the first allocation method not only address the issues of excessive super block capacity and low physical block utilization in conventional approaches, but also leverage the parallel processing capability of the storage system. While maintaining system performance, the super block allocation strategy of the present disclosure improves resource utilization and data processing efficiency when the system encounters bad blocks.

In an embodiment, referring to FIG. 5, FIG. 5 is a schematic diagram illustrating the plane-based second allocation method according to an embodiment of the present disclosure. The diagram illustrates the super block allocation when the memory module 220 has 2 chip enable signals (CE0 and CE1). In FIG. 5, blank squares represent physical blocks. As shown in FIG. 5, the storage system has two channels, namely channel 0 (CH0) and channel 1 (CH1), connected to chip CE0 and chip CE1, respectively.

In this embodiment, since the number of chip enable signals (CE count) is only 2, it is not possible to use the chip-based first allocation method to form chip enable groups (CEGs). The memory controller 210 selects the plane-based second allocation method according to the number of chips enable signals (CE count). Specifically, the memory controller 210 divides the 4 planes within each chip into 2 plane groups, namely plane group PLG1 and plane group PLG2. Plane group PLG1 comprises plane 0 and plane 1, and plane group PLG2 comprises plane 2 and plane 3.

As shown in FIG. 5, the memory controller 210 establishes two mapping paths: mapping path A51 corresponds to plane group PLG1, and mapping path A52 corresponds to plane group PLG2. Through these mapping paths, the memory controller 210 divides the physical blocks at the same index positions within the plane groups of chips CE0 and chip CE1 into one super block.

Specifically, for plane group PLG1, super block SB11 comprises the physical blocks at the same index positions in plane 0 and plane 1 of chip CE0 and plane 0 and plane 1 of chip CE1, totaling 4 physical blocks. Similarly, super block SB12 is composed of 4 physical blocks at another index position within plane group PLG1, and so on, up to super block SB1N.

For plane group PLG2, super block SB21 comprises the physical blocks at the same index positions in plane 2 and plane 3 of chip CE0 and plane 2 and plane 3 of chip CE1, totaling 4 physical blocks. Similarly, super blocks SB22 through SB2N are each composed of 4 physical blocks at the corresponding index positions within plane group PLG2.

In an embodiment, the memory controller 210 may implement specific parallel operations using super blocks divided by the second allocation method. Specifically, the memory controller 210 may simultaneously perform different types of operations on a plurality of super blocks belonging to different plane groups (PLGs). For example, the memory controller 210 may perform a read operation on super block SB11 of plane group PLG1 while simultaneously performing a write operation on super block SB21 of plane group PLG2. This operation mode leverages the physical independence between different plane groups (PLGs), improving the parallel processing capability of the system.

In an embodiment, one advantage of the plane group allocation strategy is that it leverages channel-level parallel processing capability. Referring to FIG. 5, although the storage device has only 2 chip enable signals (CE0 and CE1), the two chips are connected to different channels (channel 0 and channel 1, respectively). When the memory controller 210 divides plane group PLG1 and plane group PLG2, each plane group comprises planes from two different channels, i.e., plane group PLG1 and plane group PLG2 each comprise the corresponding planes from CE0 on channel 0 and CE1 on channel 1. This configuration enables the memory controller 210 to simultaneously send commands and transfer data in parallel through two channels when accessing either plane group, improving data processing efficiency. For example, when reading super block SB11, the memory controller 210 may simultaneously access plane 0 and plane 1 of chip CE0 through channel 0, and access plane 0 and plane 1 of chip CE1 through channel 1, achieving true channel-level parallel processing. This channel-level parallelism, combined with multi-plane parallel operations within plane groups, provides the second allocation method with efficient data throughput capability, maintaining considerable performance even under conditions of a limited number of chips enable signals (CE count).

The memory controller 210 may simultaneously perform different types of operations on a plurality of super blocks belonging to different plane groups (PLGs), achieving operation-type-level parallelism.

Specifically, in an embodiment, the memory controller 210 may perform a read operation on super block SB11 of plane group PLG1 while simultaneously performing a write operation on super block SB21 of plane group PLG2. This parallel operation mode leverages the physical independence between different plane groups (PLGs), avoiding resource contention and operational interference.

For example, when the host system 10 requests to read certain data while simultaneously needing to write new data, the memory controller 210 may allocate the read operation to plane group PLG1 while simultaneously allocating the write operation to plane group PLG2, thereby satisfying two different types of requests simultaneously, improving system response speed and processing efficiency.

In an embodiment, during garbage collection, the memory controller 210 may simultaneously migrate valid data in the first super block SB1N belonging to the first plane group PLG1 to the second super block SB2N belonging to the second plane group PLG2. This inter-plane-group data migration process leverages the advantages of channel-level parallelism and plane-level parallelism.

Specifically, the memory controller 210 first reads valid data in parallel through channel 0 and channel 1 from the four physical blocks of super block SB1N (located in plane 0 and plane 1 of chip CE0 and chip CE1, respectively). Subsequently, the memory controller 210 writes the data in parallel through the same two channels to the four physical blocks of super block SB2N (located in plane 2 and plane 3 of chip CE0 and chip CE1, respectively). This efficient inter-plane-group data migration mechanism reduces the time overhead of garbage collection operations.

Furthermore, in an embodiment, the memory controller 210 also utilizes the multi-plane command mechanism to simultaneously operate the second predetermined number of planes of each super block. In this embodiment, the second predetermined number is 2, i.e., each plane group comprises 2 planes. Through the multi-plane command mechanism, the memory controller 210 is able to simultaneously send commands to plane 0 and plane 1 of chip CE0 and simultaneously send commands to plane 0 and plane 1 of chip CE1, achieving plane-level parallel operations. This multi-level parallelism mechanism (including channel-level parallelism, chip-level parallelism, and plane-level parallelism) enables the second allocation method to achieve maximum performance optimization under conditions of limited hardware resources.

In an embodiment, since plane group PLG1 and plane group PLG2 share the same physical chip, direct inter-chip data transfer faces limitations. The memory controller 210, when performing a garbage collection operation, typically needs to utilize the buffer memory 214 as an intermediate data staging area. Specifically, valid data read from super block SB1N of plane group PLG1 needs to be first transferred to the buffer memory 214 and then written to super block SB2N of plane group PLG2.

However, the memory controller 210 may implement an optimized data transfer path, utilizing a channel cross-transfer mechanism to minimize data transfer latency. Under this mechanism, the memory controller 210 may configure a channel cross data path to achieve efficient migration of valid data, specifically:
1. Channel 0 reads the data of plane 0 and plane 1 of chip CE0 in plane group PLG1, and simultaneously, through the fast channel of the buffer memory 214, routes the data to channel 1 to be written to plane 2 and plane 3 of chip CE1 in plane group PLG2.
2. In parallel, channel 1 reads the data of plane 0 and plane 1 of chip CE1 in plane group PLG1 and routes the data to channel 0 through another fast channel, to be written to plane 2 and plane 3 of chip CE0 in plane group PLG2.

Although this channel cross-transfer mechanism still relies on the internal data path of the buffer memory 214, it may reduce data migration latency by optimizing data flow direction and reducing buffering overhead. The memory controller 210 configures a dedicated pass-through data channel, such that data undergoes only the minimum necessary processing in the buffer memory 214 (such as address translation and error checking), without fully buffering the data content, thereby achieving efficiency approaching that of direct transfer.

Through the above mechanisms, even under the condition where plane groups share the same physical chip, the system may still achieve efficient data migration, improve garbage collection performance, and provide an optimized storage management solution for the storage device 20 with a limited number of chip enable signals (CE count).

Based on the above embodiments, by implementing this plane group-based parallel operation strategy, the memory controller 210 is able to leverage the potential of limited hardware resources, optimizing storage resource utilization and system stability.

The present embodiment further provides a computer program product, comprising computer-readable code, or a non-volatile computer-readable storage medium carrying computer-readable code, wherein when the computer-readable code is executed in a processor, the processor performs the steps of the above-mentioned memory management method. The computer program product may be implemented specifically by means of hardware, firmware, software, or a combination thereof. In one optional embodiment, the computer program product is embodied as a computer storage medium; in another optional embodiment, the computer program product is embodied as a software product, such as a Software Development Kit (SDK), and so forth.

According to the technical solutions of the present disclosure, the present disclosure achieves the following technical effects:

First, the memory management method provided by the present disclosure is capable of flexibly adapting to different hardware configurations, automatically selecting the optimal super block allocation strategy according to the number of chip enable signals (CE count) of the memory module 220. When the number of chip enable signals (CE count) is relatively large, the first allocation method is adopted; when the number of chip enable signals (CE count) is relatively small, the second allocation method is adopted, enabling the memory controller to adapt to storage devices of different specifications.

Second, by forming super blocks of smaller capacity, the present disclosure effectively improves the utilization rate of physical blocks in the memory module 220. Compared with the conventional approach of binding the same physical block indices of all chips and planes into one super block, the allocation strategy of the present disclosure reduces resource waste caused by bad blocks.

Third, the smaller-capacity super block structure optimizes garbage collection efficiency. Since the amount of data processed in each garbage collection operation is reduced, the latency of a single garbage collection is lowered, and the response speed of the storage device is improved.

Fourth, the present disclosure achieves an efficient parallel operation mechanism under different allocation methods. The first allocation method supports multi-level parallelism comprising inter-chip enable group (CEG) parallelism, inter-chip parallelism, and plane-level parallelism; the second allocation method achieves inter-plane group (PLG) parallelism and multi-plane command parallelism, maintaining good data processing performance even under conditions with a limited number of chip enable signals (CE count).

Fifth, the present disclosure optimizes the data migration path, reducing the transit time of data in the buffer memory through channel parallelism and pass-through data transfer mechanisms, accelerating valid data migration during the garbage collection process, and further improving access efficiency.

In summary, the memory management method provided by the present disclosure, by selecting a super block allocation strategy according to the number of chip enable signals (CE count), optimizes system performance while improving storage resource utilization, providing a storage management solution for storage devices of different specifications.

Finally, it should be noted that the above embodiments are only intended to illustrate the technical solutions of the present invention, rather than to limit them. Although the present invention has been described in detail with reference to the foregoing embodiments, those of ordinary skill in the art should understand that they may still modify the technical solutions described in the foregoing embodiments, or make equivalent substitutions for some or all of the technical features therein; and such modifications or substitutions do not cause the essence of the corresponding technical solutions to depart from the scope of the technical solutions of the embodiments of the present invention.

What is claimed is:

1. A memory management method, applied to a storage device configured with a memory module, the memory module having a plurality of chips, each chip having a plurality of planes, and each plane having a plurality of physical blocks, wherein the method comprises:
obtaining the number of chip enable signals (CE count) of the memory module;
selecting a target allocation method from a plurality of allocation methods according to the number of chip enable signals (CE count), wherein the plurality of allocation methods comprise a first allocation method based on the plurality of chips and a second allocation method based on the plurality of planes; and
dividing the plurality of physical blocks into a plurality of super blocks based on the target allocation method.

2. The method as claimed in claim 1, wherein selecting the target allocation method from the plurality of allocation methods according to the number of chip enable signals (CE count) comprises:
when the number of chip enable signals (CE count) is not less than a predetermined threshold, selecting the first allocation method as the target allocation method; and
when the number of chip enable signals (CE count) is less than the predetermined threshold, selecting the second allocation method as the target allocation method.

3. The method as claimed in claim 2, wherein the first allocation method based on the plurality of chips comprises:
dividing the plurality of chips into a plurality of chip enable groups (CEGs), each chip enable group (CEG) comprising a first predetermined number of chips; and
dividing the same physical blocks of the same plane of all chips within each chip enable group (CEG) into one super block, such that the number of physical blocks in each super block is the first predetermined number multiplied by the number of planes of the plurality of planes.

4. The method as claimed in claim 2, wherein the second allocation method based on the plurality of planes comprises:
dividing the plurality of planes into a plurality of plane groups (PLGs), each plane group (PLG) comprising a second predetermined number of planes; and
for each plane group (PLG), dividing the same physical blocks within the plane group (PLG) of all chips into one super block, such that the number of physical blocks in each super block is the number of chip enable signals (CE count) multiplied by the second predetermined number.

5. The method as claimed in claim 3, further comprising implementing parallel operations using super blocks divided by the first allocation method, wherein the parallel operations comprise:
sending read or write commands respectively to a plurality of super blocks belonging to different chip enable groups (CEGs), implementing parallel operations among super blocks;
within a same super block, simultaneously accessing physical blocks on different chips within the chip enable group (CEG), and utilizing a multi-plane command mechanism to simultaneously operate a plurality of planes within each chip, implementing dual parallelism of inter-chip parallelism and intra-plane parallelism; and
when performing a garbage collection operation, migrating, as a whole, valid data in a first super block belonging to a first chip enable group (CEG) to a second super block belonging to a second chip enable group (CEG), while utilizing the multi-plane command mechanism to implement parallel migration of data within chips.

6. The method as claimed in claim 4, further comprising implementing parallel operations using super blocks divided by the second allocation method, wherein the parallel operations comprise:
simultaneously performing different types of operations on a plurality of super blocks belonging to different plane groups (PLGs), such that while a super block of one plane group (PLG) performs a read operation, a super block of another plane group (PLG) may perform a write operation;
during garbage collection, simultaneously migrating valid data in a first super block belonging to a first plane group (PLG) to a second super block belonging to a second plane group (PLG); and
utilizing a multi-plane command mechanism to simultaneously operate the second predetermined number of planes of each super block.

7. The method as claimed in claim 3, wherein the first predetermined number is 2, wherein dividing the plurality of chips into the plurality of chip enable groups (CEGs) comprises:
every 2 chips forming one chip enable group (CEG); and
the 2 chips within each chip enable group (CEG) corresponding to 2 channels respectively.

8. The method as claimed in claim 4, wherein the second predetermined number is 2, wherein dividing the plurality of planes into the plurality of plane groups (PLGs) comprises:
every 2 planes forming one plane group (PLG); and
the 2 planes within each plane group (PLG) corresponding to 2 channels respectively.

9. A memory controller, configured to control a storage device configured with a memory module, the memory module having a plurality of chips, each chip having a plurality of planes, and each plane having a plurality of physical blocks, wherein the memory controller comprises:
a memory interface control circuit, configured to be electrically connected to the memory module; and
a processor, electrically connected to the memory interface control circuit, wherein the processor is further electrically connected to a connection interface circuit of the storage device, so as to be electrically connected to a host system,
wherein the processor is configured to:
obtain the number of chip enable signals (CE count) of the memory module;
select a target allocation method from a plurality of allocation methods according to the number of chip enable signals (CE count), wherein the plurality of allocation methods comprise a first allocation method based on the plurality of chips and a second allocation method based on the plurality of planes; and
divide the plurality of physical blocks into a plurality of super blocks based on the target allocation method.

10. The memory controller as claimed in claim 9, wherein selecting the target allocation method from the plurality of allocation methods according to the number of chip enable signals (CE count) comprises:
when the number of chip enable signals (CE count) is not less than a predetermined threshold, selecting the first allocation method as the target allocation method; and
when the number of chip enable signals (CE count) is less than the predetermined threshold, selecting the second allocation method as the target allocation method.

11. The memory controller as claimed in claim 10, wherein the first allocation method based on the plurality of chips comprises:
dividing the plurality of chips into a plurality of chip enable groups (CEGs), each chip enable group (CEG) comprising a first predetermined number of chips; and
dividing the same physical blocks of the same plane of all chips within each chip enable group (CEG) into one super block, such that the number of physical blocks in each super block is the first predetermined number multiplied by the number of planes of the plurality of planes.

12. The memory controller as claimed in claim 10, wherein the second allocation method based on the plurality of planes comprises:
dividing the plurality of planes into a plurality of plane groups (PLGs), each plane group (PLG) comprising a second predetermined number of planes; and
for each plane group (PLG), dividing the same physical blocks within the plane group (PLG) of all chips into one super block, such that the number of physical blocks in each super block is the number of chip enable signals (CE count) multiplied by the second predetermined number.

13. The memory controller as claimed in claim 11, wherein the method further comprises implementing parallel operations using super blocks divided by the first allocation method, wherein the parallel operations comprise:
sending read or write commands respectively to a plurality of super blocks belonging to different chip enable groups (CEGs), implementing parallel operations between super blocks;
within a same super block, simultaneously accessing physical blocks on different chips within the chip enable group (CEG), and utilizing a multi-plane command mechanism to simultaneously operate a plurality of planes within each chip, implementing dual parallelism of inter-chip parallelism and intra-plane parallelism; and
when performing a garbage collection operation, migrating, as a whole, valid data in a first super block belonging to a first chip enable group (CEG) to a second super block belonging to a second chip enable group (CEG), while utilizing the multi-plane command mechanism to implement parallel migration of data within chips.

14. The memory controller as claimed in claim 12, wherein the method further comprises implementing parallel operations using super blocks divided by the second allocation method, wherein the parallel operations comprise:
simultaneously performing different types of operations on a plurality of super blocks belonging to different plane groups (PLGs), such that while a super block of one plane group (PLG) performs a read operation, a super block of another plane group (PLG) may perform a write operation;
during garbage collection, simultaneously migrating valid data in a first super block belonging to a first plane group (PLG) to a second super block belonging to a second plane group (PLG); and
utilizing a multi-plane command mechanism to simultaneously operate the second predetermined number of planes of each super block.

15. The memory controller as claimed in claim 11, wherein the first predetermined number is 2, wherein dividing the plurality of chips into the plurality of chip enable groups (CEGs) comprises:
every 2 chips forming one chip enable group (CEG); and
the 2 chips within each chip enable group (CEG) corresponding to 2 channels respectively.

16. The memory controller as claimed in claim 12, wherein the second predetermined number is 2, wherein dividing the plurality of planes into the plurality of plane groups (PLGs) comprises:
every 2 planes forming one plane group (PLG); and
the 2 planes within each plane group (PLG) corresponding to 2 channels respectively.
